(19) United States
(12) Patent Application Publication
(10) Pub. No.: US 2005/0090618 A1
(43) Pub. Date: Apr. 28, 2005

(54) Rubber composition for transmission belt, manufacturing method for the same and transmission belt using the same

(75) Inventor: Shigeki Okuno, Hyogo (JP)

Correspondence Address: NIXON PEABODY, LLP, 401 9TH STREET, NW, SUITE 900, WASHINGTON, DC, 20004-2128, US

(73) Assignee: BANDO CHEMICAL INDUSTRIES, LTD., Kobe-shi (JP)

(21) Appl. No.: 10/965,897

(22) Filed: Oct. 18, 2004

(30) Foreign Application Priority Data
Oct. 27, 2003 (JP) 2003-366407

(51) Int. Cl. C08L 53/00

(52) U.S. Cl. 525/232

(57) ABSTRACT

A rubber composition for power transmission belts in a sea-island structure contains an ethylene-α-olefin elastomer containing ethylene of 60 mass % or less in a sea phase, a hydrogenated acrylonitrile-butadiene rubber of which bonded acrylonitrile amount is 30 mass % or less in an island phase and an organic peroxide. The metal salt of unsaturated carboxylic acid is dispersed in each of the ethylene-α-olefin elastomer in the sea phase and the hydrogenated acrylonitrile-butadiene rubber in the island phase

### CROSS REFERENCE TO RELATED APPLICATION

This Non-provisional application claims priority under 35 U.S.C. §119(a) on Patent Application No. 2003-366407 filed in Japan on Oct. 27, 2003, the entire contents of which are hereby incorporated by reference.

### BACKGROUND OF THE INVENTION

1. Field of the Invention

The present invention relates to rubber compositions for transmission belts, manufacturing methods thereof and transmission belts using them.

2. Description of the Prior Art

Transmission belts are classified generally into friction transmission belts that perform power transmission utilizing friction force against pulleys and toothed belts that perform power transmission utilizing physical engagement with pulleys.

Referring to the friction transmission belts, there are various types of belts, in addition to traditional flat belts, such as V ribbed belts for driving auxiliary equipment of automobile engines, raw edge V belts represented by single cogged V belts (of which inner peripheral face is cogged) and double cogged V belts (of which inner peripheral face and back face are cogged) used for gear change in bicycles and the like, hybrid V belts (a plurality of blocks are engaged with a pair of right and left tension bands at a given pitch and at regular intervals in a longitudinal direction of the belt) used in dry CVT (continuous variable transmission) units for automobiles.

In any types of friction transmission belts, recently, minimization of the belt width is progressed in response to demand for space saving. In association therewith, increase in transmission power per belt unit width is more desired and increase in durability against environment for use, which has been becoming severer, such as temperature increase is also desired. For this reason, the rubber materials used for friction transmission are required to have characteristic balance among heat aging resistance, cracking resistance, low permanent strain, high elasticity, low self heating, abrasion resistance, good processability. Especially, in order to achieve heavy duty power transmission, which is the primary function, the rubber composition must have high elasticity after crosslink.

For satisfying the above requirements, as disclose in Japanese Patent Application Laid Open Publication No. 5-272595A, peroxide crosslinking hydrogenated acrylonitrile-butadiene rubber (herein after referred to as “H-NBR) has been used which is reinforced with a metal salt monomer of unsaturated carboxylic acid represented by zinc dimethacrylate and zinc diacrylate. In the case using this H-NBR, the more the amount of a metal salt monomer increases, the more the elasticity of the rubber material increases. This is effective for heavy duty power transmission but may cause lowering of the heat aging resistance and the cracking resistance of the rubber and increase in permanent strain. Therefore, an optimum amount of the unsaturated metal salt monomer has been found for reduction to practice, taking account of transmission power, thermal resistance, cracking resistance and lower permanent strain according to the use in the transmission belts.

In addition to the above demands, transmission belts usable in all over the world are desired which satisfy a required characteristic of durability in cold climate areas such as North America, Scandinavian countries. For satisfying these demands, ethylene-α-olefin elastomers such as ethylene-propylene copolymers (EPM), ethylene-propylene-diene terpolymers (EPDM), ethylene-octene copolymers become a focus of attention as rubber materials for transmission belts that provide both characteristics of the heat resistance and the cold resistance.

For example, Japanese Patent Application Laid Open Publication No. 5-17635 discloses a rubber composition of which elasticity is increased by blending a metal salt monomer of unsaturated carboxylic acid with an ethylene-α-olefin elastomer of which ethylene content is below about 70 mol % or by blending a metal salt monomer of unsaturated carboxylic acid with an ethylene-α-olefin elastomer of which ethylene content is above about 75 mol %.

International Publication No. 97/22662 discloses that the rubber elasticity is increased by blending a metal salt of unsaturated carboxylic acid of 32 to 100 parts by weight per 100 parts by weight of an ethylene-α-olefin elastomer.

Japanese Patent Application Laid Open Publication No. 60-92237A discloses combination of diene-based rubber and an ethylene-α-olefin elastomer. This reference discloses that about 25 to 85 parts by weight of zinc dimethacrylate is blended with 100 parts by weight of an ethylene-α-olefin elastomer, thereby providing cold resistance and high elasticity. In addition, it discloses blending of diene-based rubber such as natural rubber, SBR, NBR, CR.

Japanese Patent Application Laid Open Publication No. 5-271475 discloses combination of a H-NBR and an ethylene-α-olefin elastomer. This reference discloses that a cured compound of a rubber composition, which is less deformed permanently and is excellent in the ozone resistance, the cold resistance and the strength, is obtained by blending 10 to 80 parts by weight of an ethylene-based metal salt of unsaturated carboxylic acid such as zinc dimethacrylate and 0.2 to 10 parts by weight of an organic peroxide with 100 parts by weight of a polymer component composed of 10 to 40 parts by weight of ethylenic unsaturated nitrile-conjugated diene-based highly saturated copolymeric rubber such as a H-NRB and 90 to 60 parts by weigh of polyethylene-based polymer. As a polyethylene-based polymer, an ethylene-α-olefin elastomer composed of a group of an EMP, an EPDM and an ethylene-octene copolymer is disclosed.

Published Japanese translation of PCT international publication for patent application No. 9-500930 discloses blending of about 1 to 30 parts by weight of a metal salt of unsaturated carboxylic acid with 100 parts by weight of an ethylene-α-olefin elastomer for reinforcing the rubber, and blending of a H-NBR up to 25 parts by weight.

International Publication No. 97/22663 discloses blending of 5 to 80.5 parts by weight of a metal salt of unsaturated carboxylic acid with a base rubber made of 41 to 49 parts by weight of an ethylene-α-olefin elastomer and 59 to 61 parts by weight of a H-NBR.

On the other hand, various types of toothed belts are used in various cases such as office equipment of copying machines and printers, general industrial equipment such as injection molding presses, and equipment used for driving overhead cams, fuel injection pumps, water pumps and oil pumps for engines of automobiles. The toothed belts of all types are desired to have high transmission power under heavy duty application at high temperature.

For example, toothed belts for driving the aforementioned overhead cam, fuel injection pumps, water pumps, oil pumps and the like are desired to have high transmission power in association with a fact that the circumstances for use (i.e., higher engine output, temperature rise in atmosphere, and the like) has become severer. Further, the toothed belts are desired to have good characteristics of heat resistance, cold resistance, cracking resistance, low permanent strain, elasticity, low self heating and abrasion resistance, as well as in the friction transmission belts. Toothed belts used for injection molding presses in general industry are recently desired to have high transmission power, as well as the toothed belts for automobiles.

As a load applied to a belt increases, shearing stress applied to the tooth part becomes large. This causes tooth chipping due to cracking or separation of a rubber tooth, resulting in a shortened lifetime. For tackling this problem, it is known that increase in rigidity of the tooth part increases the durability. Accordingly, it is necessary for increasing the rigidity of the toothed part to increase the elasticity of the rubber composing the tooth part.

For increasing the rigidity, various kinds of rubber compositions in which H-NBR is reinforced with a metal salt of unsaturated carboxylic acid for providing high elasticity, heat resistance, high strength, abrasion resistance and the like have been proposed as rubber materials of toothed belts for heavy duty power transmission.

Further, as commercially available H-NBRs reinforced with a metal salt of unsaturated carboxylic acid, there are exemplified Zeoforte ZSC (trade name) produced by ZEON CORPORATION and Therban ART (trade name) produced by Bayer Ltd. Since the H-NBRs reinforced with the metal salt of unsaturated carboxylic acid have high elasticity, heat resistance and oil resistance, the application of the rubber composition to the tooth rubber remarkably increases the durability of the tooth part.

To the contrary, following problems are pointed out.
1) Cracking resistance at low temperature is insufficient due to high polarity.
2) Compression permanent strain of the rubber is severe due to ionic bond of a metal salt of unsaturated carboxylic acid, with a result that apparent elongation by permanent deformation of the tooth part is large.

For tackling the above problems, Japanese Patent Application Laid Open Publication No. 2002-194114 discloses that the glass transition temperature is lowered by lowering the amount of bonded acrylonitrile of a H-NBR to 10 to 30% or by increasing the amount of a plasticizer.

Rubber compositions for transmission belts are also required to have good rubber processability such as kneading processability, rolling processability, in addition to balance of the characteristics as above. In detail, because the rubbers composing transmission belts are required to have low self heating at dynamic deformation, the blending amount of an inorganic filler in the rubber composition such as carbon black, silica, calcium carbonate must be set low, namely, set to 50 parts by weight or less per 100 parts by weight of a material rubber. However, such a less blended filler causes inferior smoothness of the sheet surface after processing the rubber composition into a sheet by roll milling. On the other hand, an organic filler in the form of short fiber is generally used. However, the rubber composition containing such a less amount of the organic filler causes extremely low flowability of the rubber composition and less integrality of the rubber composition at kneading, with a result of less processability in roll milling.

For tackling the above problems, Japanese Patent Application Laid Open Publication No. 2002-81506 discloses the use of a material rubber (ethylene-α-olefin elastomer) of a low molecular weight, for example, having 50 or lower of Mooney viscosity ML₍₁₊₄₎ at 100° C. (about 33 or lower at 125° C.) in order to improve the processability of the rubber composition for transmission belts with which short fiber is blended with a small amount of a filler as above. According to this gazette, the rubber elasticity of an uncrosslinked rubber composition is lowered and the flowability thereof is increased, with a result of good processability in rolling and kneading. In general, Mooney viscosity ML₍₁₊₄₎ of an ethylene-α-olefin elastomer used for transmission belts is 50 or less at 125° C. and Mooney viscosity ML₍₁₊₄₎ is 40 or less in the case for better processability.

Referring to rubber materials for friction transmission belts, however, when a satisfactory flexibility is obtained at lower temperature below −35° C., the amount of bonded acrylonitrile in a H-NBR is lowered and a large amount of a plasticizer such as oil must be added even if the H-NBR is reinforced with the metal salt of unsaturated carboxylic acid. This results in lower elasticity and severer permanent strain, whereby the aforementioned characteristic balance that transmission belts are required becomes worse.

Referring to rubber materials of which base material is an ethylene-α-olefin elastomer, increase in the amount of a filler such as carbon black for increasing the elasticity increases extremely the self heating in bending of the rubber and lowers the cracking resistance, which means no reduction to practice.

Blending a metal salt monomer of unsaturated carboxylic acid with an ethylene-α-olefin elastomer attains less strength. This might be because of less dispersiveness of the metal salt monomer. While the elasticity is increased, the cracking resistance becomes severely worse in this case, with a result of no improvement in flexibility and resistance to permanent strain. The lowering of the cracking resistance might be caused by less dispersiveness of the metal salt monomer, also.

The ethylene content of higher percentage, i.e., 75% or more in the ethylene-α-olefin elastomer could attain high strength, but causes crystallization at low temperature, thereby lowering the flexibility of the belt at low temperature.

To the contrary, blending of a large amount of a metal salt of unsaturated carboxylic acid with an ethylene-α-olefin elastomer leads to high elasticity of the rubber, so that it is difficult to obtain a rubber having excellent cracking resistance. Even if the cracking resistance would be increased by adding a large amount of a plasticizer, compressive permanent strain becomes severer. As such, V belts are liable to be deformed by creep against severe side pressure from the pulleys, with no durability attained.

Combination of an ethylene-α-olefin elastomer with a diene-based rubber improves the problem of permanent strain but worsens heat aging resistance. Thus, no composition is obtained which can withstand thermal history in high temperature that are required in recent years.

Further, it has been examined that an H-NBR is combined with an ethylene-α-olefin elastomer and an ethylene-based metal salt of unsaturated carboxylic acid is blended therewith. However, various kinds of conditions such as a blending ratio of the rubber composition to the elastomer composition, a kind of the elastomer composition, the degree of crystallization, and the molecular weight must be examined for obtaining the characteristic balance suitable for heavy duty power transmission belts, among heat resistance, cold resistance, cracking resistance, low permanent strain, elasticity, low self heating, abrasion resistance and processability. Thus, it is difficult to select optimum conditions. Even though such optimum conditions could be selected, it is difficult to always obtain stable quality.

Referring to toothed belts, when the amount of bonded acrylonitrile in a H-NBR reinforced with a metal salt of unsaturated carboxylic acid is lowered to 10 to 30% for attaining excellent cracking resistance at low temperature, the compressive permanent strain becomes large. Further, increase in the amount of the plasticizer further worsens the compressive permanent strain.

Referring to rubber composition in which an inorganic filler is less blended and short fiber is mixed, the processability is improved when Mooney viscosity ML₍₁₊₄₎ of the material rubber is lowered as described above. While, for increasing the strength, fatigue resistance and abrasion resistance after crosslink, it is necessary to increase the molecular weight of the ethylene-α-olefin elastomer, which makes the processability worse. Addition of oil for improving the processability necessitates a large amount of a filler such as carbon black for attaining optimum elasticity after crosslink, with a result of poor fatigue resistance and increase in self heating at dynamic deformation.

In consequence, it is too difficult to provide both excellent rubber properties after crosslink and processability before crosslink in the case where an ethylene-α-olefin elastomer is use as a material rubber of a rubber composition for transmission belts.

### SUMMARY OF THE INVENTION

The present invention has its object of improving heat resistance, cold resistance, cracking resistance, low permanent strain, elasticity, low self heating, abrasion resistance on balance in manufacturing friction transmission belts or toothed belts by combining a H-NBR and an ethylene-α-olefin elastomer.

To attain the above object, a sea-island structure is employed in which a H-NBR in an island phase is dispersed in a sea phase in an ethylene-α-olefin elastomer and a metal salt of unsaturated carboxylic acid is dispersed throughout the sea phase and the island phase.

Specifically, the rubber composition for transmission belts of the present invention includes:
an ethylene-α-olefin elastomer which composes a sea phase in a sea-island structure and of which ethylene content is 60 mass % or less;
a hydrogenated acrylonitrile-butadiene rubber which composes an island phase in the sea-island structure and of which bonded acrylonitrile content is 30 mass % or less;
a metal salt of unsaturated carboxylic acid dispersed in each of said ethylene-α-olefin elastomer in the sea phase and said hydrogenated acrylonitrile rubber the island phase; and
organic peroxide.

With the above structure, heat resistance, cold resistance and cracking resistance, which are the basic characteristics required for transmission belts, are improved and high elasticity for enabling heavy duty power transmission and excellent rubber processability are attained.

In detail, in the present invention, a H-NBR, which is a rubber material excellent in cracking resistance, and an ethylene-α-olefin elastomer, which is a rubber material excellent in heat resistance and cold resistance, are combined to attain excellent heat resistance, cold resistance and cracking resistance, wherein a metal salt of unsaturated carboxylic acid is blended for attaining high elasticity. However, blending of the metal salt of unsaturated carboxylic acid with the H-NBR and the ethylene-α-olefin elastomer lowers the cracking resistance while increasing the elasticity.

One of the important features of the present invention lies in that the above problem are solved by employing the sea-island structure and dispersing well the metal salt of unsaturated carboxylic acid.

First, the ethylene-α-olefin elastomer is in the sea phase for ensuring the cold resistance by taking an advantage of the characteristic of the ethylene-α-olefin elastomer. By ensuring the cold resistance by employing the ethylene-α-olefin elastomer in the sea phase, a less amount of a plasticizer such as oil is required, so that high elasticity is attained and severe permanent strain can be avoided.

In the present invention, distribution of the island phase of the H-NBR in the sea phase prevents growth of a micro-crack that may be generated in the sea phase. The relationship between the prevention of crack growth and wide dispersion of the metal salt of unsaturated carboxylic acid is as follows.

When the metal salt of unsaturated carboxylic acid is blended to the sea phase (ethylene-α-olefin elastomer) and to the island phase (H-NBR), the sea phase becomes harder than the island phase because of difference in property of the material. Therefore, if the metal salt of unsaturated carboxylic acid is excessively blended in the sea phase so that the amount of the metal salt is locally increased due to poor dispersion of the metal salt in the sea phase, a crack is liable to be generated in the sea phase and the thus generated crack immediately grows larger. Therefore, the growth of the crack cannot be prevented even in the case where the island phase is distributed in the sea phase.

For tackling this problem, the metal salt of unsaturated carboxylic acid is distributed in both the sea phase and the island phase so that a crack is hard to be generated in the sea phase and growth of a micro-crack that may be generated is inhibited by the island phase. Thus, the elasticity of transmission belts is increased while preventing cracking resistance thereof from being lowered.

Blending of a large amount of the metal salt of unsaturated carboxylic acid with only the ethylene-α-olefin elastomer may increase permanent strain. However, by employing the above sea and island structure, the island phase distributed in the sea phase, which exhibits a characteristic like a shape-memory effect to the rubber material, prevents permanent strain, with a result that both high elasticity and low permanent strain are attained.

Further, another important feature of the present invention lies in that wide dispersion of the metal salt of unsaturated carboxylic acid in both the sea phase and the island phase enables to employ the ethylene-α-olefin elastomer having a Mooney viscosity (ML₍₁₊₄₎ at 125° C.) of 60 or more. By this employment, the rubber strength after crosslink is ensured, the fatigue resistance (low permanent strain, low self heating) and the abrasion resistance after crosslink are improved, and the processability of the rubber composition is prevented from lowering.

With high Mooney viscosity by using the ethylene-α-olefin elastomer of high molecular weight as described above, the rubber property after crosslink is improved but the processability of the rubber composition is lowered. Especially, with less oil, kneading processability, rolling processability and calendering processability of the rubber composition become poor. For tackling this problem, the H-NBR in the island phase in which the metal salt of unsaturated carboxylic acid is dispersed is distributed in the ethylene-α-olefin elastomer in the sea phase. With this structure, the processability of the rubber composition is excellent and both the processability of the rubber composition before curing and the rubber property after curing are improved.

In other words, the present inventors have found a H-NBR reinforced with the metal salt of unsaturated carboxylic acid serves to improve the processability of a high Mooney viscosity ethylene-α-olefin elastomer. Whereby, a high Mooney viscosity (60 or more in ML₍₁₊₄₎ at 125° C.) ethylene-α-olefin elastomer, which has not conventionally been able to be used due to low processability, can be used as a material rubber of a rubber composition for transmission belts in which a filler is less blended and which includes short fiber. Hence, the strength of crosslinked rubber is increased, the characteristics such as fatigue resistance, setting resistance, abrasion resistance are improved and processability before crosslink is improved.

The metal salt of unsaturated carboxylic acid is preferably powder of which mass ratio is 50% or more and which has the grain diameter of 0.1 μm or less. Also, the grain diameter of the metal salt of unsaturated carboxylic acid is preferably 0.3 μm or less. By this size setting, effective micro-dispersion of the metal salt of unsaturated carboxylic acid is attained in both the island phase and the sea phase.

Since organic peroxide is used as a crosslinking agent in the present invention, heat aging resistance of the rubber is excellent.

The content of bonded acrylonitrile in the H-NBR is set to 30% or less, which leads to an advantage in excellent cold resistance and low permanent strain of the transmission belts. When the amount of bonded acrylonitrile in the H-NBR exceeds 30 mass %, the content of oil to be added must be increased for ensuring flexibility at low temperature. As a result, the resistance to permanent strain is lowered and balance between the cracking resistance and the resistance to permanent strain is liable to be lost at low temperature.

In order to further enhance the cold resistance, the main component of the ethylene-α-olefin elastomer is preferably in amorphous grade.

Moreover, since the content of the ethylene in the ethylene-α-olefin elastomer is set to 60 mass % or more in the present invention, the cold resistance of the transmission belts is further enhanced. 60 mass % or more ethylene content increases Gehman torsion t₅ and the cracking resistance at low temperature is lowered.

The above organic peroxide is not limited particularly and may be, for example, 2,5-dimethyl-2,5di(t-butylperoxy)-3-hexyne, 2,5-dimetyl-2,5-di(t-butylperoxy)hexane, 2,2-bis(t-butylperoxy)-p-di-isopropylbenzene, dicumylperoxide, di-t-butylperoxide, t-butylperoxidebenzoate, 1,1-bis(t-butylperoxy)-3,3,5-trimethylcyclohexane, 2,4-dichlorobenzoylperoxide, benzoilperoxide, p-chlorobenzoylperoxide, 2,4-dicumylperoxide, dialkylperoxide, ketalperoxide. Further, a general crosslinking agent such as sulfur, polyfunctional monomers, which is typified by higher ester of methacrylate, 1,2-poly butadiene, triallylisocyanurate, dioxime, N,N-m-phenylenedimaleimide may be used according to necessity.

Moreover, it is preferable to include at least one white inorganic filler selected from the group of silica, talk, mica, calcium carbonate, zinc oxide and magnesium oxide. By this inclusion, the elasticity and the strength of the transmission belts are increased.

Wherein, when a larger amount of a reinforcing agent which interacts much with a rubber and of which structure is large, such as carbon black, is used, self heating at dynamic strain in transmission belts is increased, with a result of acceleration of thermal aging, permanent strain and crack generation. Therefore, less amount of carbon black to be added is desirable and it is preferable to use no carbon black.

Coloring to white by filling a white inorganic filler or to color to another color by adding a pigment without carbon black used is preferable. In so doing, decorativeness of the products is improved and progression in aging of the transmission belt can be easily judged from the color change by referencing to the thermal history, with a result that the thermal history and the lifetime can easily judged.

Polyethylene powder of ultrahigh molecular weight or polyethylene fiber of ultrahigh molecular weight is preferably blended as an abrasion regulator. With the powder or fiber blended, improvements in abrasion resistance, low friction coefficient and stability are attained without lowering the cracking resistance of the transmission belts, which leads to increase in durability and in silence.

Though increase in abrasion resistance and lowering of the friction coefficient can be attained with the use of an antifriction material such as organic or inorganic short fiber, fluoroplastic powder, graphite, molybdenum disulfide, ceramic powder, glass beads and the like, the use of such fillers extremely lowers the cracking resistance of the rubber composition.

In contrast, the polyethylene powder of ultrahigh molecular weight and the polyethylene fiber of ultrahigh molecular weight, that is, thermoplastic resins, are firmly cured and adhered to the ethylene-α-olefin elastomer by means of organic peroxide. Thus, increase in abrasion resistance, lowering of the friction coefficient and stabilization are attained with no cracking resistance lowered.

It should be noted that the above short fiber and antifriction agent can be used as far as the cracking resistance is not so lowered.

The above rubber composition for transmission belts can be applied to various types of friction belts for heavy duty power transmission such as heavy duty power transmission flat belts, V ribbed belts for driving auxiliaries of automobile engines, raw edge V belts typified by single cogged V belts or double V cogged belts used for gear change in bicycles, hybrid V belts used for dry CVT units for automobiles.

In the case where a rubber composing the friction face of a transmission friction belt for heavy duty power transmission is made of the above rubber composition for transmission belts, it is preferable to adjust the rubber composition so that the rubber hardness is in the range between 40 and 60, both inclusive, in durometer type D and t₅ in Gehman torsion test is −35° C. or lower. Further, the extraction amount of acetone is 9% or lower.

By the above adjustment, the characteristics of heat resistance, cold resistance, cracking resistance, low permanent strain, elasticity, low self heating and abrasion resistance are balanced and the performance and the durability are enhanced in application to the above belts.

In detail, when the rubber hardness in durometer type D is less than 40, deformation by compressive stress or shearing stress becomes too severe to transmit heavy duty power. Further, when the rubber hardness is more than 60, the cracking resistance is lowered and heat generated due to bending is severe while high transmission power can be obtained.

When t₅ in Gehman torsion test is above −35° C., the cold resistance of the rubber is insufficient. Therefore, a crack is generated in the rubber for use in the belt in cold climate areas, which invites lowering of the durability.

When the acetone extraction amount is more than 9%, it is difficult to increase the elasticity of the crosslinked body of the rubber composition, the abrasion resistance of the rubber is lowered and the permanent strain of the rubber is sever, so that the shape of a belt capable of maintaining the belt performance cannot be maintained. When the acetone extraction amount is 9% or less by reducing the amount of low molecular weight additive irrelevant to crosslink of the rubber such as oils (as plasticizers) and antioxidants, the elasticity, the abrasion resistance, the resistance to permanent strain can be balanced and the transmission power in heavy duty application and the durability of the belts are increased.

The above rubber composition for transmission belts can be applied to friction belts for middle-level duty power transmission such as flat belts for middle-level duty power transmission, V ribbed belts for driving auxiliaries of automobile engines. For application thereto, it is preferable to adjust the rubber composition so that the rubber hardness is in a range between 80 and 90, both inclusive, in durometer type A and t₅ in Gehman torsion test is −35° C. or lower, and the acetone extraction amount is 12% or less.

By the above adjustment, the characteristics of heat resistance, cold resistance, cracking resistance, resistance to permanent strain, elasticity, low self heating and abrasion resistance are balanced and the performance and durability required for the belts are enhanced in application to the above belts. Since the power required for the belts for middle-level duty power transmission is small in comparison with those for heavy duty power transmission, the performance and the durability required for the belts are balanced by setting the elasticity (hardness) of the rubber to slightly low with priority for obtaining excellent cracking resistance.

In the case where the rubber hardness, t₅ and the acetone extraction amount are out of the above set ranges, the same problems rise as in the aforementioned friction belts for heavy duty power transmission.

Referring to toothed belts for heavy duty power transmission, the rubber composition may be adjusted so that the rubber hardness is in the range between 80 and 95, both inclusive, in durometer type A and t₅ in Gehman torsion test is −35° C. or lower and the acetone extraction amount is 10% or lower. By this adjustment, the characteristics of heat resistance, cold resistance, cracking resistance, low permanent strain, elasticity, low self heating and abrasion resistance are balanced and the performance and the durability of the belts are enhanced in application to the above belts.

In this case, when the rubber hardness in durometer type A is less than 80, the rigidity of the tooth part is so small that large sharing stress is applied between the tooth part and the core wires in heavy duty application, with a result of invitation of breakage because of separation. When the rubber hardness is more than 95, the cracking resistance in the tooth part is lowered and a tooth is liable to be chipped due to a crack. When t₅ in Gehman torsion test is above −35° C., the cold resistance of the rubber is insufficient. Therefore, a crack may be generated in the rubber in the use of the belt in cold climate areas, which invites lowering of the durability.

When the acetone extraction amount is more than 10%, the rigidity is lowered due to lowering of the elasticity of the rubber, which invites the aforementioned breakage because of separation. Further, the permanent strain of the rubber is severe, so that apparent elongation of the belt by permanent strain in the tooth part becomes large and malfunction of engagement may be caused. When the acetone extraction amount is 10% or less by reducing the amount of a low molecular weight additive irrelevant to crosslink such as oils (as plasticizer) and antioxidants, the rigidity of the tooth part can be increased and the permanent strain in the tooth part can be minimized, with a result that the characteristics of the high transmission power and the durability are balanced in toothed belts for heavy duty power transmission.

The method for manufacturing the rubber composition for transmission belts will be described next.

This manufacturing method includes the step of kneading a H-NBR containing a component of a metal salt of unsaturated carboxylic acid, an ethylene-α-olefin elastomer containing no compound of a metal salt of unsaturated carboxylic acid and a rubber compound containing an organic peroxide so as to obtain a sea-island structure, where the ethylene-α-olefin elastomer constitutes a sea phase and the H-NBR constitutes an island phase, and the metal salt of unsaturated carboxylic acid is dispersed in the sea phase and the island phase.

Specifically, the H-NBR containing the component of the metal salt of unsaturated carboxylic acid and the ethylene-α-olefin elastomer containing no component of the metal salt of unsaturated carboxylic acid are put into a mixer and pre-milled, and then, the compounding ingredient for rubber containing organic peroxide is put thereinto and kneaded. Or, the H-NBR containing the component of the metal salt of unsaturated carboxylic acid, the ethylene-α-olefin elastomer containing no component of the metal salt of unsaturated carboxylic acid and the compounding ingredient for rubber containing an organic peroxide are put into a mixer and kneaded. Thus, the above rubber compound is obtained.

In order to attain both high elasticity and excellent cracking resistance which are required for rubber compositions for transmission belts, it is desirable that the metal salt of unsaturated carboxylic acid is evenly dispersed in the island phase of the H-NBR and the sea phase of the ethylene-α-olefin elastomer and is uniformly dispersed in each phase.

In the case where the H-NBR and the ethylene-α-olefin elastomer are pre-milled and the metal salt of unsaturated carboxylic acid is put thereinto and kneaded or in the case where those three are put into a mixer and kneaded concurrently, uniform dispersion of the metal salt of unsaturated carboxylic acid is hard to obtain. The metal salt may be uniformly dispersed by extending the kneading period or increasing the temperature for kneading. However, in a kneading apparatus having a large capacity, dispersion variation is liable to be caused among the kneading rots and stable quality is hard to provide.

In the above manufacturing method, the total required amount of the metal salt of unsaturated carboxylic acid is finely dispersed in the H-NBR beforehand, and then, is mixed with the ethylene-α-olefin elastomer containing no component of the metal salt. Thus, the rubber composition is easily obtained in which the metal salt of unsaturated carboxylic acid is evenly, uniformly dispersed in the island phase of H-NBR and the sea phase of the ethylene-α-olefin elastomer. With the thus obtained rubber composition, the dispersion variation of the metal salt, which is caused among the kneading rots, is minimized and stable quality is obtained even using a kneading aaparatus having a large capacity.

Referring to the method for finely dispersing the metal salt of unsaturated carboxylic acid into the H-NBR, either methods may be employed, namely, a method of directly mixing and kneading the H-NBR and powder of the metal salt of unsaturated carboxylic acid or a method of generating the metal salt of unsaturated carboxylic acid in the H-NBR in situ by mixing and kneading the reactant (i.e., unsaturated carboxylic acid and powder of a metal compound such as oxide and hydroxide of the metal) with the H-NBR.

As the aforementioned H-NBR containing the reactant of the metal salt of unsaturated carboxylic acid, Zeoforte ZSC (product of ZEON CORPORATION) and Therban ART (product of Bayer, Ltd.) are used.

In order to obtain the ethylene-α-olefin elastomer in the sea phase and the H-NBR in the island phase, the compound ratio E/R of the ethylene-α-olefin elastomer E to the H-NBR R is preferably set to 50/50 to 90/10, more preferably set to 55/45 to 85/15.

As the ethylene-α-olefin elastomer, ethylene propylene copolymers (EPM), ethylene propylene diene terpolymers (EPDM) and ethylene-octene coporlymers are preferable.

As the unsaturated carboxylic acid composing the metal salt of unsaturated carboxylic acid, unsaturated monocarboxylic acid such as acrylic acid, methacrylic acid, unsaturated dicarboxylic acid such as maleic acid, fumaric acid, itaconic acid, and monomethylmaleic acid and monoethylitaconic acid may be used. The metal is not specifically limited only if unsaturated carboxylic acid and salt are formed, and may be beryllium, magnesium, calcium, strontium, barium, titanium, chromium, molybdenum, manganese, iron, cobalt, nickel, copper, silver, zinc, cadmium, aluminum, tin, lead, mercury, antimony and the like. Among all, zinc diacrylate and zinc dimethacrylate are preferable to be used.

### BRIEF DESCRIPTION OF THE DRAWINGS

The other objects, features and advantages will be cleared by the following description with reference to accompanying drawings.

FIG. 1 is a perspective view of a cogged V belt.

FIG. 2 is a side view of the cogged V belt.

FIG. 3 is a perspective view of a hybrid V belt.

FIG. 4 is a section taken along a line IV-IV in FIG. 3.

FIG. 5 is a side view of a block of the hybrid V belt.

FIG. 6 is a side view of a tension band of the hybrid V belt.

FIG. 7 is a transverse section of a V ribbed belt.

FIG. 8 is a perspective view of a toothed belt.

FIG. 9 is a view showing the layout of a durability running test apparatus for a flat belt.

FIG. 10 is a photograph through a transmission electron microscope of a rubber composition.

FIG. 11 is a view showing the layout of a durability running test apparatus for a V ribbed belt.

FIG. 12 is a view showing the layout of a low temperature running test apparatus for a V ribbed belt.

FIG. 13 is view showing the layout of a running test apparatus for a toothed belt.

FIG. 14 is a table indicating in detail blended medicines of rubber compositions.

FIG. 15 is a table indicating components and properties of rubber compositions.

FIG. 16 through FIG. 18 are tables each indicating components, properties and belt performances of rubber compositions.

### DETAILED DESCRIPTION OF THE PREFERRED EMBODIMENTS

The preferred embodiments of the present invention will be described in detail with reference to the drawings.

(Construction of Heavy Duty Power Transmission Belt)

Cogged V Belt

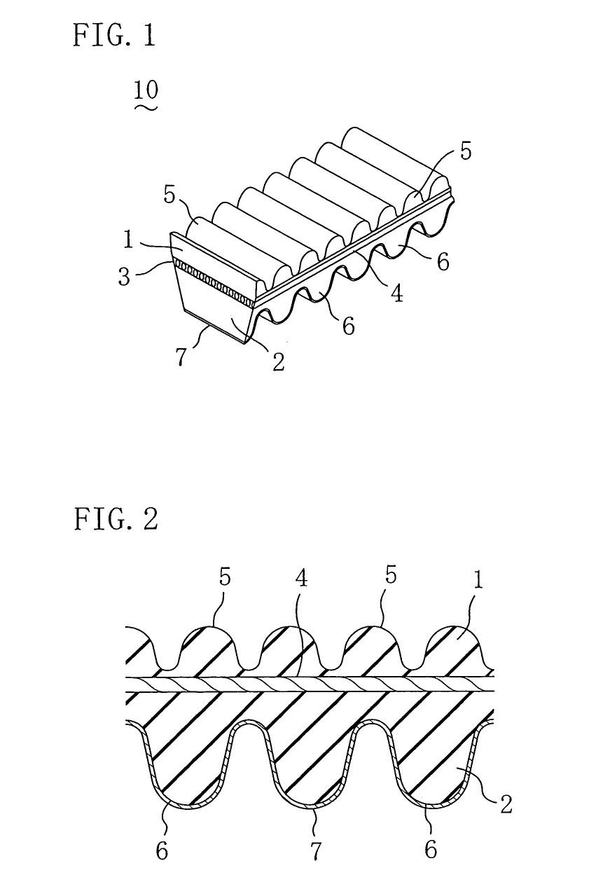

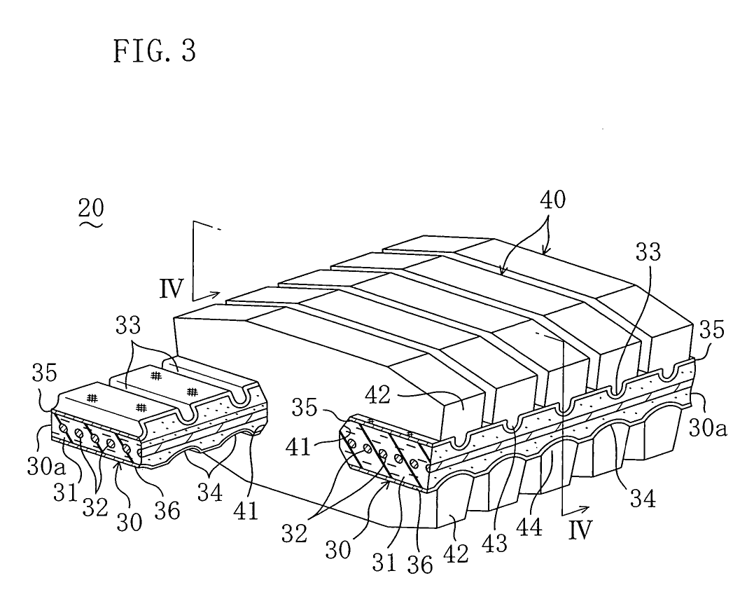

FIG. 1 and FIG. 2 show a cogged V belt 10.

The cogged V belt 10 includes: an upper rubber layer 1 on the back face side of the belt; a lower rubber layer on the inner peripheral side of the belt; an adhesion rubber layer 3 provided between the upper rubber layer 1 and the lower rubber layer 2; and core wires 4 embedded in the adhesion rubber layer 3. The surface portion of the upper rubber layer 1 is formed in a corrugated shape in such a fashion that a plurality of cogs 5 are formed at a predetermined pitch in a longitudinal direction of the belt. The surface portion of the lower rubber layer 2 is provided in a corrugated shape in such a fashion that a plurality of cogs 6 are formed at a predetermined pitch in a longitudinal direction of the belt. The surface of the lower rubber layer 2 is covered with a lower canvas 7. The core wires 4 are provided spirally so as to extend in the longitudinal direction of the belt and to be arranged at a predetermined pitch in the belt width direction.

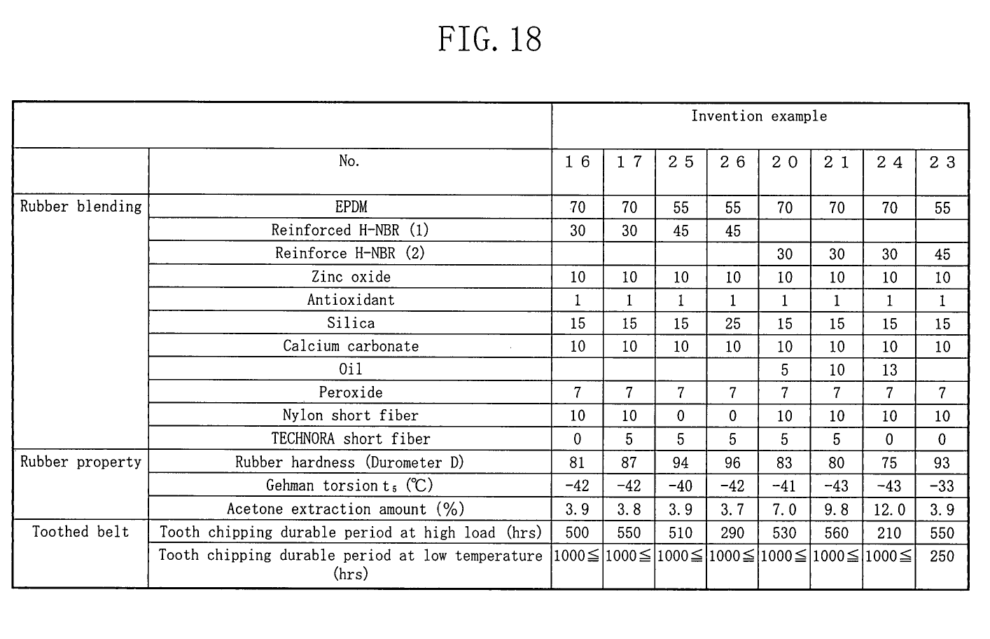

Kevlar (registered trademark), which is para-aramid fiber produced by Dupont, is used for the core wires 4, a nylon canvas is used for the lower canvas 7, and a rubber composition according to the present invention (shown in FIG. 16 described later) is used for upper rubber layer 1 and the lower rubber layer 2. In the rubber layers 1 and 2, short fiber is oriented in the width direction of the belt.

Hybrid V Belt for Heavy Duty Power Transmission

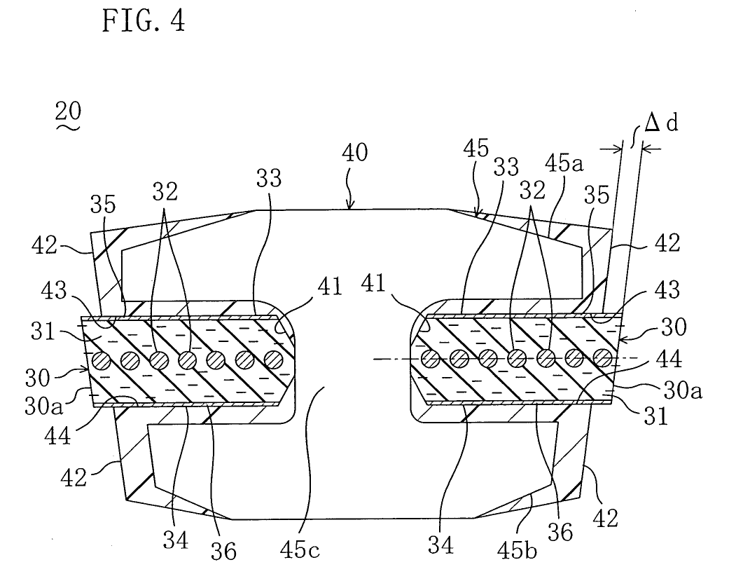

FIG. 3 shows a hybrid V belt 20 for heavy duty power transmission.

The V belt 20 is composed of a pair of right and left endless tension bands 30, 30, and a plurality of blocks 40, 40 engaged with the tension bands 30, 30 at regular intervals left in the longitudinal direction of the belt.

Each tension band 30 is integrally composed of: a shape retaining rubber layer 31, core wires 32 made of aramid short fiber, extending therein in the longitudinal direction of the belt and arranged spirally at a predetermined pitch in the width direction of the belt; and upper and lower canvases 35, 36 provided to respectively cover the upper surface and the lower surface. Trench-shaped upper concave portions 33, 33 . . . are formed in the upper surface portion of each tension band 30 so as to extend in the width direction of the belt at a predetermined pitch correspondingly to the blocks 40, 40, respectively, and lower concave portions 34, 34 are formed in the lower surface portion of each tension band 30 so as to extend in the width direction of the belt at a predetermined pitch correspondingly to the upper concave portions 33, 33, respectively.

The core wires 32 have been subjected to adhesion treatment with isocyanate or solution of resorcin formalin latex (RFL) for increasing the adhesiveness to the rubber.

Both the upper canvas 35 and the lower canvas 36 are formed of aramid fabric subjected to treatment for providing elasticity in the longitudinal direction of the belt and subjected to rubber covering.

The blocks 40 each have an engaging groove 41 for detachably engaging with the corresponding right and left tension bands 30 sideward and contact portions 42, 42 at upper and lower side portions of the engaging groove 41 so as to come in contact with the pulley groove faces. The respective tension bands 30, 30 engage with the respective engaging grooves 41, 41 of the respective blocks 40, 40.

In each block 40, an upper convex portion 43 fitted to the upper concave portion 33 of the upper surface portion of the tension band 30 and extending in the belt width direction is formed in the upper wall face of the engaging grove 41, and a lower convex portion 44 fitted to the lower convex portion 34 of the lower surface portion of the tension band 30 and extending in the belt width direction is formed in the lower wall face of the engaging groove 41. The upper and lower concave portions 33, 34 of the tension bands 30 are fitted to the upper and lower convex portions 43, 44 of the blocks 40, respectively, so that each block 40 are engaged with the tension bands 30 so as not to shift in the longitudinal direction.

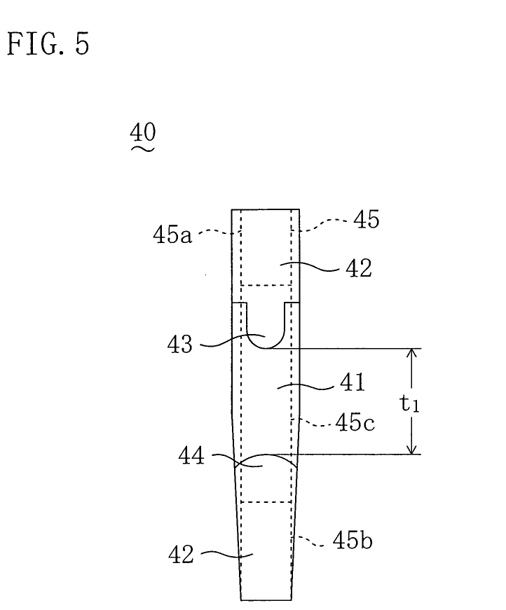

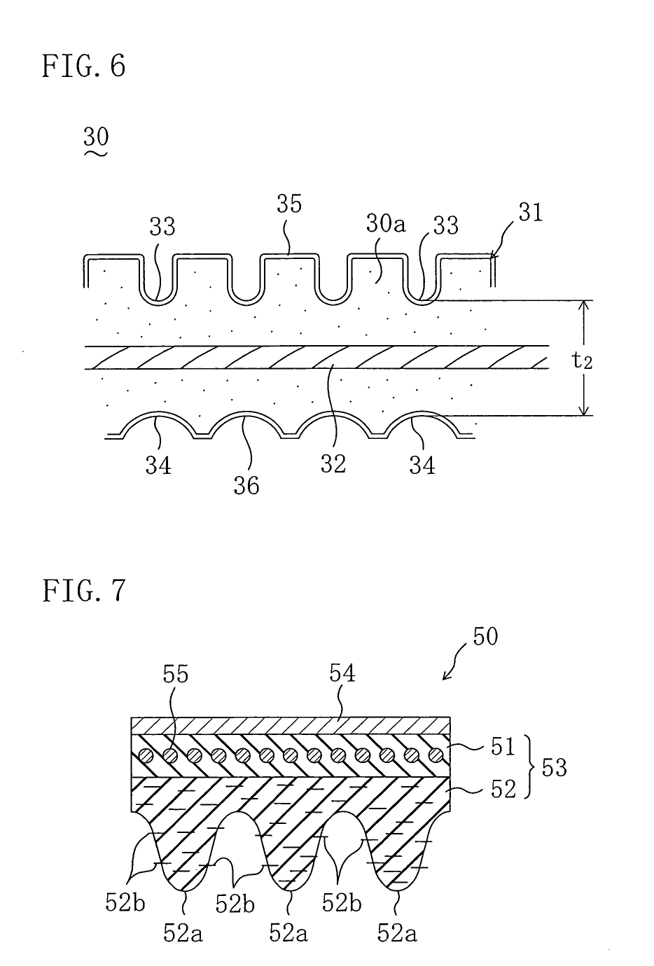

The blocks 40 are formed of a thermohardening phenol resin material with which aramid short fiber or milled carbon fiber is mixed. A high strength, high elasticity reinforcing material 45 made of a lightweight aluminum alloy or the like is embedded in each block 40 so as to be located at the substantial center in the thickness direction of each block 40, as shown in FIG. 4 and FIG. 5.

The reinforcing material 45 in substantially H-shape is composed of upper and lower beams 45a, 45b extending in the width direction of the belt (side-to-side direction), and a center pillar 45c that connects vertically the central parts of the beams 45a, 45b.

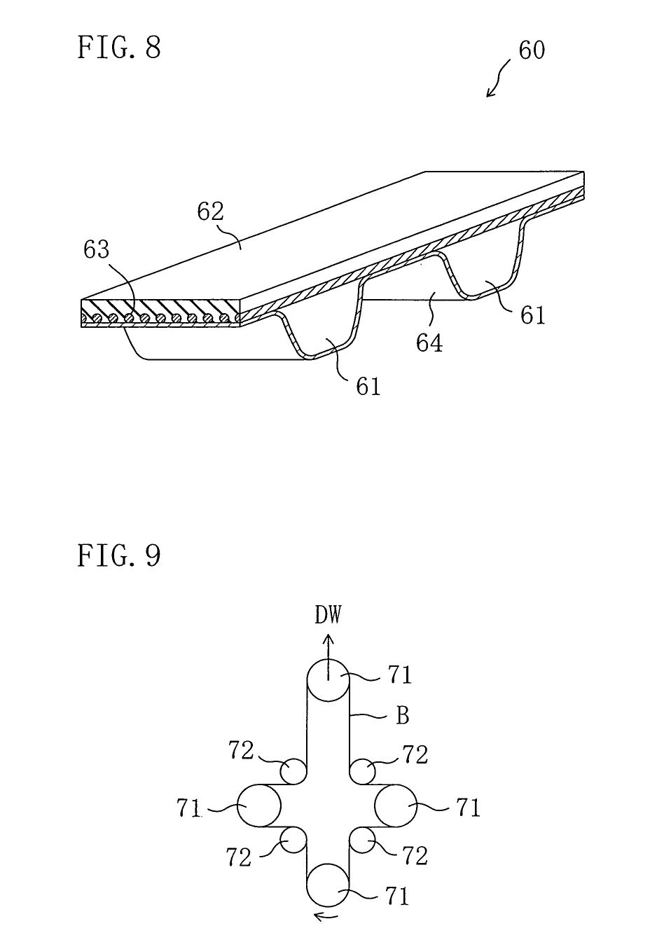

Further, the distance t2 between the bottom surface of the upper concave portion 33 of each tension band 30 (precisely, upper surface of the upper canvas 35) and the bottom surface of the lower concave portion 34 corresponding to the upper concave portion 33 (precisely, the lower surface of the lower canvas 36) shown in FIG. 6 is set to, for example, about 0.03 mm to about 0.15 mm larger (t2>t1) than the distance t1 between the lower end of the upper convex portion 43 and the upper end of the lower convex portion 44 of each block 40. Therefore, the tension bands 30 are compressed in the thickness direction by the blocks 40 to be assembled and fixed to the blocks 40.

As shown in FIG. 4, the side face 30a of each tension band 30 protrudes (protrusion size Δd) slightly outward in the width direction of the belt from the level of the contact portions 42, 42 of each resin block 40. In consequence, the tension band side face 30a is in contact with the pulley grove face together with the contact portions 42 on the sides of each block 40 so that each block 40 and each tension band 30 receive and share the side pressure from the pulley. As a result, an impact at contact of each block 40 to the pulley groove is buffered by the side face 30a of each tension band 30.

The rubber composition (shown in FIG. 16, described later) according to the present invention is used for the shape retaining rubber layer 31. In the shape retaining rubber layer 31, short fiber is oriented in the belt width direction.

V Ribbed Belt

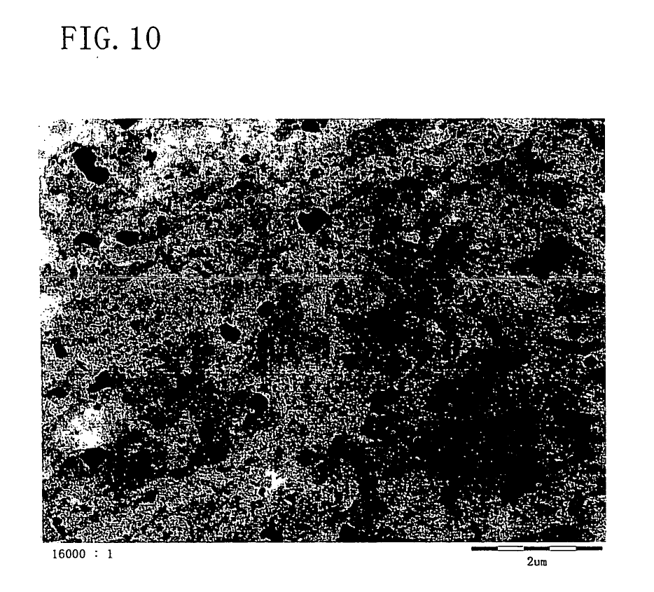

FIG. 7 shows a V ribbed belt 50.

The V ribbed belt 50 has a belt body 53 composed of an adhesion rubber layer 51 and a ribbed rubber layer 52 at the inner periphery of the belt. A back face canvas 54 is attached to the back face of the adhesion rubber layer 51, and a plurality of ribs 52a, 52a, 52a are arranged at the bottom face of the ribbed rubber layer 52 in the longitudinal direction of the belt at a predetermined pitch in the width direction of the belt. Core wires 55 extending substantially the longitudinal direction of the belt are provided spirally at the center in the thickness direction of the adhesion rubber layer 51 at a pitch in the width direction of the belt.

The rubber composition (shown in FIG. 17, described later) according to the present invention is used for the ribbed rubber layer 52, with which short fiber 52b, 52b . . . such as nylon fiber, aramid fiber oriented in the width direction of the belt is mixed for increasing the elasticity in the width direction of the belt. A canvas of nylon fiber is used for the back canvas 54. The core wires 55 are made of polyester fiber.

Toothed Belt

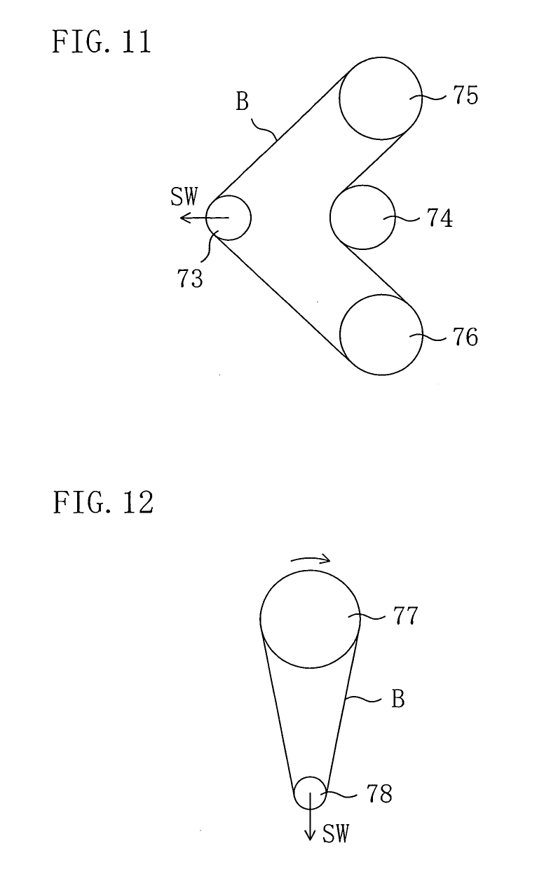

FIG. 8 shows a toothed belt 60.

The toothed belt 60 includes a rubber tooth portion 61 forming belt teeth projecting from the inner periphery of the belt at a predetermined pitch in the longitudinal direction of the belt, a back rubber 62 serving as a belt back portion, core wires 63 each extending spirally in the longitudinal direction of the belt and arranged at a pitch in the width direction of the belt, and a tooth fabric 64 covering the surface on the rubber tooth portion side.

The rubber composition (shown in FIG. 18, described later) according to the present invention is used for the rubber tooth portion 61. Short fiber is mixed in the rubber tooth portion 61 and oriented in the longitudinal direction of the belt. Glass cords having high elasticity are used for the core wires 63.

<Medicines Blended in Rubber Composition>

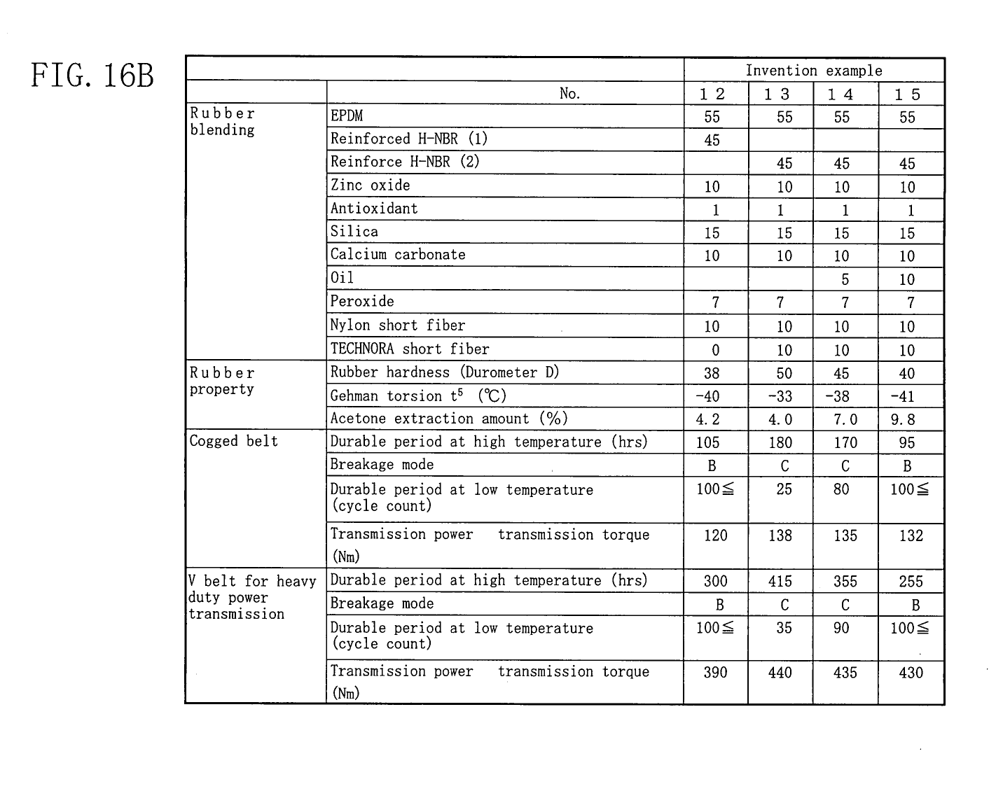

FIG. 14 lists in detail blended medicines of the rubber compositions used for the rubber layers 1, 2 of the cogged V belt, the shape retaining rubber layer 31 of the tension bands 30 of the hybrid V belt, the rubbed rubber layer 52 of the V ribbed belt and the rubber tooth portion 61 of the toothed belt, and the rubber compositions used in the other invention examples and comparative examples. In the drawing, EPDM contains 54% of ethylene and has 74 of Mooney viscosity (ML₍₁₊₄₎ at 125° C.). Zinc dimethacrylate contained in the H-NBRs (1) and (2) reinforced with a metal salt of dimethacrylate is generated by an “in situ” method and zinc dimethacrylate in the rubbers (1), (2) occupies about 50% in mass ratio. Wherein, the H-NBR (1) reinforced with a metal salt of dimethacrylate and the H-NBR (2) reinforced with a metal salt of dimethacrylate are referred to simply as reinforced H-NBR (1) and reinforced H-NBR (2), respectively.

<Preparation of Rubber Composition>

In a rubber composition preparation method, a material rubber, namely, the EPDM, the reinforced H-NBR (1), the reinforced H-NBR (2) or a H-NBR were put into a mixer and pre-milled solely or in combination, and then, an antioxidant, a zinc oxide, a filer, oil, a crosslinking agent and short fiber were put into the mixer in this order and kneaded. Wherein, there are examples in which oil is added and not added in the invention examples and the comparative examples, respectively.

<Rubber Compositions in Invention Examples 1-8 and Comparative Examples 1-7>

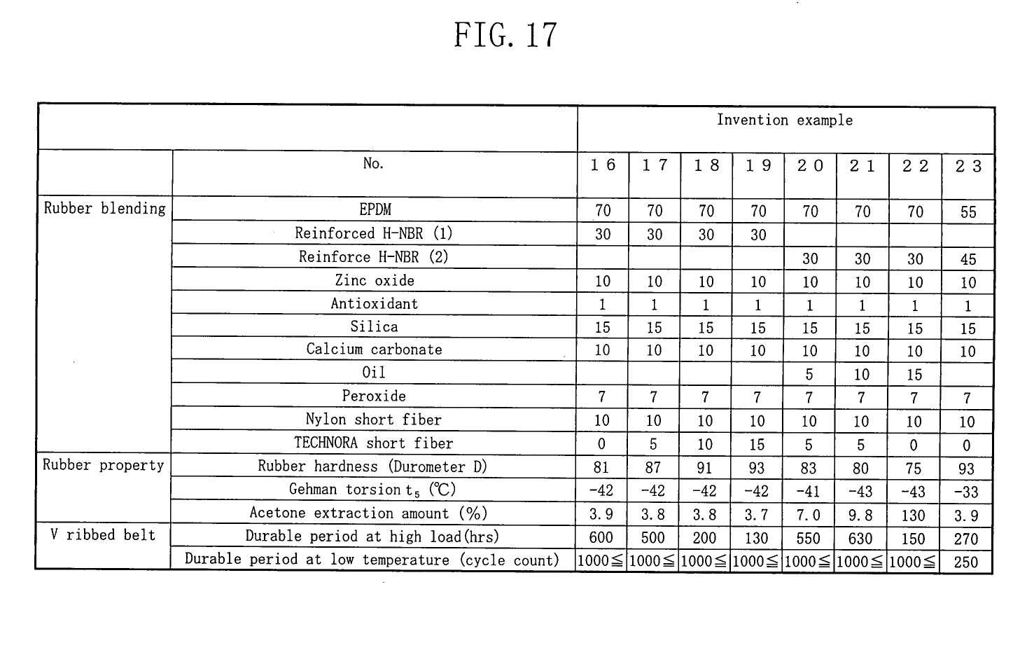

In the invention examples and the comparative examples indicated in FIG. 15, respective rubber compositions were prepared according to the respective rubber blending ratios (data in the columns of rubber blending ratios in FIG. 15 and other columns in the tables in the other drawings are represented as a unit of parts by weight.), and crosslinked. The rubber properties of the thus obtained rubber compositions after crosslink and the processability thereof were measured by the following methods.

Measurement of Rubber Hardness

Each rubber composition was processed into a sheet-like shape having a thickness of about 2.2 mm by roll milling and was pressed for formation for 20 minutes at 170° C. to obtain a crosslinked sheet of 2 mm in thickness. Three rubber sheets obtained by the above method were stacked and the rubber hardness in durometer type D was measured in accordance with JIS K6253. The rubber hardness in durometer type A was also measured as needed. In addition, after thermal aging by heating in an oven at 150° C. for 168 hours, the rubber hardness in durometer type D of the rubber sheet was measured.

Measurement of Dynamic Viscosity

Tan δ of each crosslinked rubber sheet was obtained by the following method.
Measurement tool: RSAII (product of Rheometrics, Inc.)
Measured condition: 3 Kgf/cm² of a static load in tensile mode, 1% of dynamic strain, 100° C. of temperature and 10 Hz of frequency
Wherein, the tensile direction was a direction (anti-calendaring direction) that formed a right angle with the orientation direction of the polymer chain.

Measurement of Friction and Abrasion Characteristics

The friction and abrasion characteristics of the crosslinked rubber were evaluated by a pin-on-desk friction abrasion test.
Measurement conditions: 1.25 Mpa of bearing stress, 0.15 m/s of sliding speed and 100° C. of temperature
Material on which rubber slides: FC material (surface roughness Ra=0.3 μm)
Measurement time: 24 hours.

For the abrasion resistance, the difference in sample height between before and after the test was obtained and displacement by abrasion was evaluated. Each friction coefficient was obtained as an average value of the values measured during a period between 10 hours after and 24 hours after from the start in the test. In addition, as the stability of the friction coefficient, variation ratio (%) of the friction coefficient was calculated as a ratio, in percentage term, of a difference between the maximum value and the minimum value of the friction coefficient in the 24 hours to the friction coefficient obtained as above.

Evaluation of Cold Resistance

Each value t₅ (temperature at which torsion rigidity becomes as 5 times as that at a temperature of 23° C.) obtained in Gehman torsion test was measured in accordance with JIS K6261. Each sample used in this measurement was cut into a strip of which width was 3 mm and the longitudinal direction was intersect at a right angle with the orientation direction of the short fiber.

Measurement of Acetone Extraction Amount

Each crosslinked rubber sheet was sliced to have a thickness of 0.5 mm or less and the acetone extraction amount was measured using an extraction apparatus of type I in accordance with the A method in JIS K6229.

Workability Judgment of Rubber Compositions

Kneading processability of each rubber composition was judged as follows.

Good: Rubber composition receives searing stress easily at kneading and is integrated after kneaded.

Fair: Rubber composition receives searing stress at kneading, can be kneaded, and is less integrated after kneaded, with many small lumps formed.

Poor: Rubber composition receives no sharing stress and cannot be kneaded.

Rolling processability of each rubber composition was judged as follows.

Good: Rubber composition is excellently wound to the roller, has less adhesiveness to the roller and has smooth surface of the sheet (2.2 mm thickness).

Fair: Rubber composition is poorly wound to the roller and is bugged. The surface of the sheet (2.2 mm thickness) is irregular.

Poor: Rubber composition is poorly wound to the roller and is bugged. The surface of the sheet (2.2 mm thickness) is irregular and many holes are formed.

Evaluation of Cracking Resistance of Rubbers

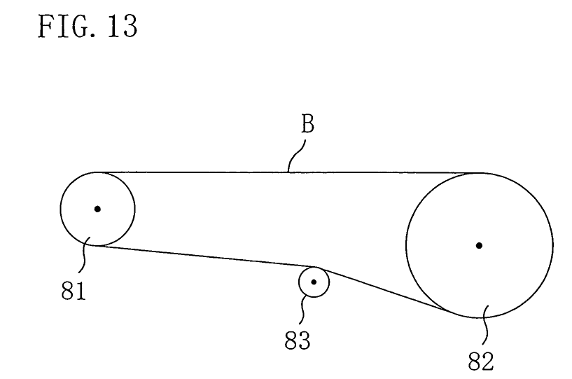

In order to evaluate the resistance to cracking caused by repetitive elongation and compression of the rubber member, endless flat belts were manufactured. The flat belts ware composed of a canvas layer, core wires and a rubber layer arranged in this order and used sample rubber compositions for the rubber layer, respectively. Each flat belt was formed so that the short fiber was oriented in the width direction of the belt. The belt width was set to 15 mm, the thickness of the rubber layer from the center line of the core wires to the outermost portion of the rubber was set to 2.5 mm. The belt length was set to 900 mm. The cracking resistance was evaluated using a belt running test apparatus having a layout as shown in FIG. 9.

In detail, in the belt running test apparatus, a belt B wound to four pulleys 71, 71, . . . and four idler pulleys 72, 72 . . . was run, so that the belt B was reversely bent four times per one round. The lower pulley (drive pulley) 71 was set to rotate at 5500 rpm and no load was applied to the other pulleys 71, 72. A dead weight was applied to the upper pulley 71 so as to apply a load of 490 N to the belt B. The atmospheric temperature was set so that the temperature of the belt surface on the rubber layer side became 130° C. The diameter of the pulleys 71 was 60 mm and that of the idler pulley 72 was 28 mm. The time period until a crack was generated in the surface portion of the rubber layer was evaluated for the cracking resistance.

Measurement of Permanent Strain of Rubbers

Each large size piece in accordance with JIS K6262 was compressed 10% at a temperature of 130° C., and then, the permanent strain after 24 hours was measured.

Result of Property Measurement

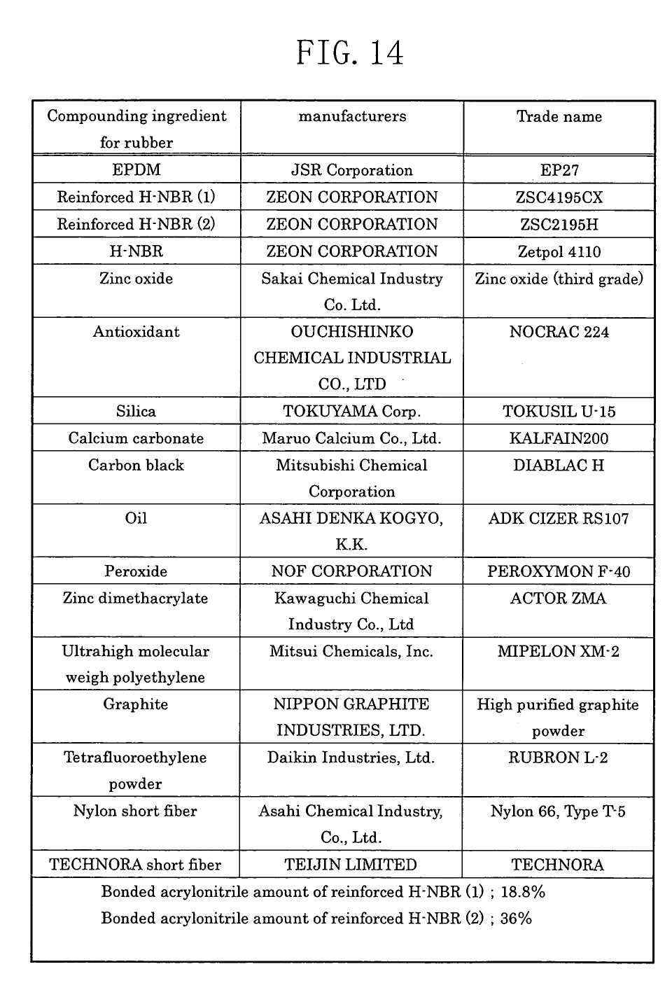

The measurement results of the properties are indicated in the lower paragraph of FIG. 15. In the rubber compositions in the invention examples 1-4, the blending ratio of the EPDM to the reinforced H-NBR (1) was different. The amount of the component of the H-NBR wass about one half of the reinforced H-NBR (1). Therefore, with the blending ratios in the invention examples 1-4, the volume ratio of the EPDM was larger than that of the H-NBR so that the EPDM was in a sea phase while the H-NBR was in an island phase. As one example, a TEM (transmission electron microscope) photograph of the crosslinked rubber sheet of the invention example 2 is shown in FIG. 10. The conditions of the TEM were as follows.
TEM conditions
Sample Manufacture
The sample was cut by a cryo-ultra microtome (sample: −120° C., knife: −120° C.)
Dying with ruthenium (using RuO₄ crystal) for 30 seconds
Observation
Acceleration voltage of 80 kV and magnification of 16000 times

Whitish parts in the drawing are the EPMD composing the sea phase and grayish spots of several micrometers in size therein is the H-NBR composing the island phase. Blackish spots whose grain size is about 0.5 μm is the filler, and numerous dispersed small blackish dots of about 0.1 μm in size is zinc dimethacrylate. It is understood from the drawing that the rubber composition has a structure in which the island phase of the H-NBR of several micrometers is distributed in the sea phase of the EPDM. It is also understood that zinc dimethacrylate is in the form of particles of about 0.1 μm and is dispersed uniformly in the entirety of the rubber composition. In other words, zinc dimethacrylate is finely dispersed in both the sea phase and the island phase. 50% or more of zinc dimethacrylate is in the form of particles having the grain size of 0.1 μm or less and no zinc dimethacrylate of which grain size exceeds 3 μm is found.

In any of the invention examples 1-4, variation in hardness of the rubber by thermal aging was small, namely, 5, which means excellent thermal resistance exhibited. The excellent thermal resistance was attained with less low molecular weight component that will be volatilized by thermal aging. The reasons for less low molecular weight component are that: both the EPDM and the H-NBR, which compose the rubber, have excellent thermal resistance; organic peroxide is used as a crosslinking agent; and the acetone extraction amount is less, namely, about 4%.

With low tan δ, self heating of the rubber at dynamic deformation wass small, which means that application to those subjected to dynamic deformation, such as belts, is suitable. In addition, it is understood that the rubber composition is excellent in friction and abrasion characteristics, processability, cold resistance (Gehman torsion t₅), permanent setting in fatigue (permanent strain) and cracking resistance. Above all, cold resistance was excellent because that the rubber composition had a structure in which the EPDM, which was excellent in cold resistance, was in the sea phase. The excellent resistance to permanent setting in fatigue was attained because of less acceleration of rubber creep with less acetone extraction amount (4%).

Further, it is considered that excellent cracking resistance was attained because: a crack was hard to be generated because zinc dimethacrylate was dispersed in the form of particles in the sea phase of the EPDM; and the island phase of the H-NBR in about several micrometers was finely distributed so that, even if a small crack was generated, the crack was prevented from growing at the interface between the sea phase and the island phase of the H-NBR.

The above EPDM had a high (74) Mooney viscosity (ML₍₁₊₄₎ at 125° C.) and high average molecular weight, so that the compressive permanent strain was small. In detail, the EPDM having Mooney viscosity below 60 resulted in severer permanent strain of 5% or more. The content of the ethylene in the above EPDM was 54% and the crystallinity of ethylene was low, which leads to excellent flexibility at low temperature. In detail, it is known that Gehman torsion t₅ rises by 5° C. or more when the content of the ethylene in the EPDM is 65% or more, which adversely influences the cracking resistance at low temperature. Further, the reinforced H-NBR (1), in which the content of bonded acrylonitrile was low, namely, 18.8%, had excellent cracking resistance at low temperature without oil added. Therefore, the cracking resistance and the resistance to permanent strain were balanced even at low temperature.

In the invention example 5, polyethylene powder of ultrahigh molecular weight was added in addition to the compound of the invention example 2. By this addition, the abrasion resistance of the rubber was improved, the friction coefficient was lowered and the stability was enhanced. In consequence, a silent friction transmission belt was achieved with the use of the rubber composition in the invention example 5. Since polyethylene of ultrahigh molecular weight was firmly crosslinked to the rubber by organic peroxide, peeling at the interface with the rubber was hard to be caused and the cracking resistance was improved. A rubber composition with which short fiber made from ultrahigh molecular polyethylene fiber (trade name: TEKMILON, product of Mitsui Chemicals, Inc.) ware mixed, instead of the polyethylene powder of ultrahigh molecular weight, attained the same effects.

In the invention examples 6 and 7, graphite powder or Teflon powder was used as an antifriction agent, instead of ultrahigh molecular weight polyethylene in the invention example 5. While such antifriction agents reduced the friction coefficient, the adhesiveness thereof at the interface with the material rubber was poor, so that the antifriction materials were liable to fall off in sliding motion. Accordingly, the abrasion amount was slightly large and variation of the friction coefficient was large in comparison with those of the invention example 5. With the use of these antifriction agents, the cracking resistance of the rubber became worse.

Hence, in the case using graphite powder or tetrafluoroethylene powder as an antifriction agent, it is preferable to adjust the amount thereof so as to less invite the above adverse effects. In addition, ultrahigh molecular weight polyethylene may be used in combination with such an antifriction agent.

In the invention example 8, part of a white filler such as silica, calcium carbonate was replaced by carbon black. With the use of carbon black, tan δ of the rubber composition became large, so that the self heating of the rubber was increased and the cracking resistance became worse. Consequently, it is understood that a less amount of or no reinforcing filler such as carbon black should be use.

Hence, silica and calcium carbonate are preferable as a filler that restrains tan δ of the rubber from lowering and that increases the elasticity of the rubber composition. In addition, other white fillers such as mica, zinc oxide, magnesium oxide are also excellent. With the use of these white fillers, the rubber composition became white. Further, the rubber composition may be colored to arbitrary optional colors with the use of pigments, which improves the decorativeness of products and enables to judge from the color appearance the degree of degradation by thermal aging of the rubber composition.

Increase in ratio of the reinforced H-NBR (1) as in the comparative example 1 led to a sea phase of the H-NBR, resulting in remarkable lowering of the cold resistance (Gehman torsion t₅).

In the comparative examples 2-4, powder of zinc dimethacrylate was mixed directly with the material rubber. These compositions had much lower cracking resistance than that of the invention examples 1-5 though none of the graphite powder, tetrafluoroethylene powder and carbon black as in the invention examples 6-8 were used. The reason for this might be that zinc dimethacrylate was less dispersed since zinc dimethacrylate was mixed directly with the material rubber.

In the comparative examples 2-4, it may be possible to enhance the cracking resistance to the level equal to those of the invention examples 1-5 by kneading for a longer time and improving the dispersion state of the zinc dimethacrylate powder. However, a kneading apparatus of which capacity is large for increasing the productivity lowers the reproducibility of the dispersion state and raises a problem of stability of the quality.

In the comparative examples 5 and 6, no H-NBR was contained in the rubber compositions. It was found that the processability of the rubber compositions was poor regardless of the presence of zinc dimethacrylate. Therefore, a flat belt cannot be manufactured with such compositions and the evaluation of the cracking resistance cannot be carried out. It is understood that in the case where a rubber composition uses less amount of a filler and an EPDM having high Mooney viscosity as in the present invention examples, the processability of the rubber composition is remarkably enhanced by adding the H-NBR and the metal salt of unsaturated carboxylic acid in the rubber composition.

In other words, the H-NBR reinforced with the metal salt of unsaturated carboxylic acid serves to improve the processability of the ethylene-α-olefin elastomer of high Mooney viscosity. Hence, the ethylene-α-olefin elastomer of high Mooney viscosity (ML₍₁₊₄₎ is 60 or more at 125° C.), which has not been able to be used because of poor processability, can be used as a material rubber of a rubber composition for power transmission belts in which a less amount of filler is blended and short fiber is mixed, with results that the characteristics of the crosslinked rubber such as strength, fatigue resistance, setting resistance and abrasion resistance are improved and the processability in the uncrosslinked state is improved.

In the case where the H-NBR (1) reinforced with zinc methacrylate and the H-NBR are used as a base rubber with no EPDM used as in the comparative example 7, it is necessary to add about 10 parts by weight of oil for providing sufficient cold resistance. However, the addition thereof increases rubber hardness variation by thermal aging and tan δ (which means increase in self heating of the rubber), and lowers the setting resistance (resistance to compressive permanent strain). In consequence, it is difficult to balance the characteristics of the rubber composition for transmission belts.

Evaluation of Rubber Composition in Cogged V Belt

The cogged V belts shown in FIG. 1 and FIG. 2 were manufactured, wherein the rubber compositions according to the respective rubber blending ratios in the respective examples in FIG. 16 were used for the upper rubber layer 1 and the lower rubber layer 2. Then, the evaluation of the rubber compositions was carried out in the following tests.

High Temperature Durability Test

A high temperature durability test was carried out in a two-shaft layout apparatus with each belt wound open. The diameters of the drive pulley and the driven pulley were set to 128 mm and 105 mm, respectively, and a bearing load (dead weight) of 1176 N (120 Kgf) was applied to the driven pulley. The drive pulley was rotated at 6000 rpm while applying a load of 44 N to the driven pulley. The temperature of the atmosphere during running was set to 110° C. and a running period until the belt was broken was used as an index for durability. The conditions of breakage were classified into the following modes.

Breakage mode A: Belt is cut from a crack generated in the bottom rubber layer.

Breakage mode B: Permanent deformation is caused in the bottom rubber layer by dynamic compressive stress from the pulley and the bottom rubber layer separates at the interface with the core wires, resulting in disassembly of the belt.

Breakage mode C: Belt is cut due to fatigue of the core wires.

Cold Resistance Test

A cold resistance test was carried out in a two-shaft layout apparatus. The diameters of the drive pulley and the driven pulley were set to 68 mm and 158 mm, respectively, and a bearing load of 1176 N (120 Kgf) was applied to the driven pulley. The driven pulley was run at 1000 rpm while no load was applied to the driven pulley. It was confirmed first that the temperature of the atmosphere was kept at −30° C. Then, after the belt was cooled while being mounted to the test apparatus for one hour, the belt was run for 5 minutes. Then, the belts were stopped running and cooled again for one hour. This cycle was repeated until a crack was generated in the bottom rubber layer. The number of cycles until a crack was generated was used as an index for cracking resistance at low temperature.

Evaluation of Transmission Power

Transmission power was evaluated in a two-shaft layout apparatus. Each diameter of the drive pulley and the driven pulley was set to 105.8 mm, and a bearing load (dead weight) of 600 N was applied to the driven pulley. The drive pulley was rotated at 3000 rpm. The temperature of the atmosphere was set to 25° C. and the transmission torque was gradually increased. The transmission torque when the slip rate of the belt reached 2% was used as an index for transmission power of the belt.

<Evaluation of Rubber Composition in Hybrid V Belt for Heavy Duty Power Transmission>

The hybrid V belts shown in FIG. 3 trough FIG. 6 were manufactured, wherein the rubber compositions according to the respective rubber blending ratios in the respective examples in FIG. 16 were used for the shape retaining rubber layer 31 in the respective belts. Then, the following test was carried out for evaluation of the respective rubber compositions.

High Temperature Durability Test

A high temperature durability test was carried out in a two-shaft layout apparatus. The diameters of the drive pulley and the driven pulley were 126 mm and 71 mm, respectively, and a bearing load (deadweight) of 1100 N was applied to the driven pulley. The axial torque of the drive shaft was set to 63 Nm and the drive pulley was rotated at 5300 rpm. The temperature of the atmosphere during running was set to 110° C. The running was continued until the belt was broken. The belt running period was used as an index for durability at high temperature. The breakages were classified into the following modes.

Breakage mode A: Belt is cut from a crack generated in the bottom rubber layer.

Breakage mode B: Permanent deformation is caused in the bottom rubber layer by dynamic compressive stress from the pulley and the bottom rubber layer separates at the interface with the core wires, resulting in disassembly of a belt.

Breakage mode C: Belt is cut due to fatigue of the core wires.

Low Temperature Durability Test

A low temperature durability test was carried out in a tow-shaft layout apparatus. The diameters of the drive pulley and the driven pulley were 68 mm and 192 mm, respectively, and a bearing load (deadweight) of 1176 N (120 Kgf) was applied to the driven pulley. No axial torque was applied to the drive shaft and the drive pulley was run at 1000 rpm. In detail, the temperature of the atmosphere was set to −35° C. first, and the belt was cooled while being mounted to the test apparatus for two hours. Then, the belt was run for 5 seconds and was stopped for 10 seconds. Three-time repetition of these was set as one cycle. This cycle was repeated until a crack was generated in the shape retaining rubber of the tension band. The number of cycles until a crack was generated was used as an index for cracking resistance at low temperature.

Evaluation of Transmission Power

Transmission power was evaluated in a two-shaft layout apparatus. Each diameter of the drive pulley and the driven pulley was set to 98.5 mm, and a bearing load (deadweight) of 3000 N was applied to the driven pulley. The drive pulley was rotated at 3000 rpm. The temperature of the atmosphere was set to 25° C. and the transmission torque was gradually increased. The transmission torque when the slip rate of the belt reached 2% was used as an index for transmission power of the belt.

Evaluation Results in Cogged V Belts and Hybrid V Belts

The results are indicated at the lower paragraph in FIG. 16 together with the rubber properties. In the invention examples 2, 9 and 10, the EPDM and the reinforced H-NBR (1) were used as a material rubber and the blending amount of TECHNORA short fiber was different. The rubber hardness in durometer type D was different and its influence can be acknowledged in the durability at high temperature, while approximately good transmission characteristics were obtained.

In the invention example 11, an excessive amount of silica was added to increase the rubber hardness in durometer type D. The cracking resistance of the rubber was poor and the period that the belt was durable at high temperature was short. In comparison with the results in the invention examples 2 and 9 to 11, a crack was generated in the rubber of both the cogged V belts and the hybrid V belts in the high temperature durability test when the rubber hardness was 60 or more, which means remarkable lowering of the durability.

Accordingly, it is understood that the rubber hardness is preferably set to 60 or less. On the other hand, in the invention example 12, no TECHNORA short fiber was blended so as to lower the rubber hardness in durometer type D. The durability at high temperature was lowered and the transmission power was also lowered. Accordingly, it is preferable to adjust the rubber composition so that the rubber hardness is 40 or more.

In the invention examples 13 to 15, the H-NBR (2) in which the amount of bonded acrylonitrile was large was used and the amount of added oil was different. In the invention example 13 in which no oil was added, the rubber hardness was high in durometer type D while Gehman torsion t₅ was higher than −35° C., which means poor durability at low temperature. When the amount of the added oil was large as in the invention examples 14 and 15, which led to a large amount of acetone extraction, Gehman torsion t₅ was lowered and the durability at low temperature was improved. However, sever permanent strain by creep of the rubber was liable to be caused and the durability at high temperature was lowered.

From the above evaluation results, it is understood that it is preferable for attaining excellent durability both at high temperature and at low temperature and transmission power required in friction belts for heavy duty power transmission to prepare a rubber composition so that the rubber hardness of the rubber material composing it is in the range between 40 and 60 in durometer type D, t₅ in Gehman torsion test is set to −35° C. or lower and the acetone extraction amount is 9% or less. The same aspects are applied to flat belts for heavy duty power transmission in addition to the cogged V belts and hybrid V belts for heavy duty power transmission.

Evaluation of Rubber Composition in V Ribbed Belt

The V ribbed belts shown in FIG. 7 were manufactured, wherein the rubber compositions according to the rubber blending ratios in the respective examples indicated in FIG. 17 were used for the ribbed rubber layer 52. These belts were evaluated in the following tests.

High Temperature Durability Test

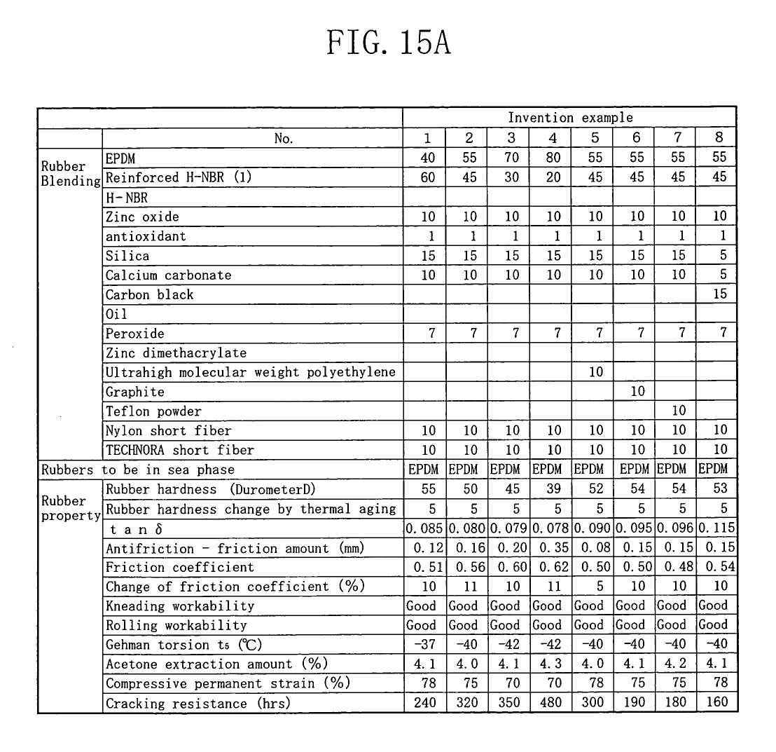

The V ribbed belt B was wound to a belt running test apparatus of which layout is as shown in FIG. 11 and the results of the test for high temperature durability were evaluated. In this time, the temperature of the atmosphere was set to 120° C. The pulley 75 was set to rotate at 4900 rpm and the pulley 76 was arranged so that the each rib of the belt B received a load of 4 kW. A set weight was applied to the pulley 73 so as to apply a load of 350 N to each rib of the belt B. The material of the pulleys 73 to 76 was S45C, the diameter of the pulleys 73, 74, 75 and 76 were set to 55 mm, 70 mm, 120 mm and 120 mm, respectively. The angle of the pulleys 73, 74 to the belt B was set to 90°. The time period from the start until a crack was generated in the surface portion of the ribbed rubber layer was used as an index for durability at high temperature.

Low Temperature Durability Test

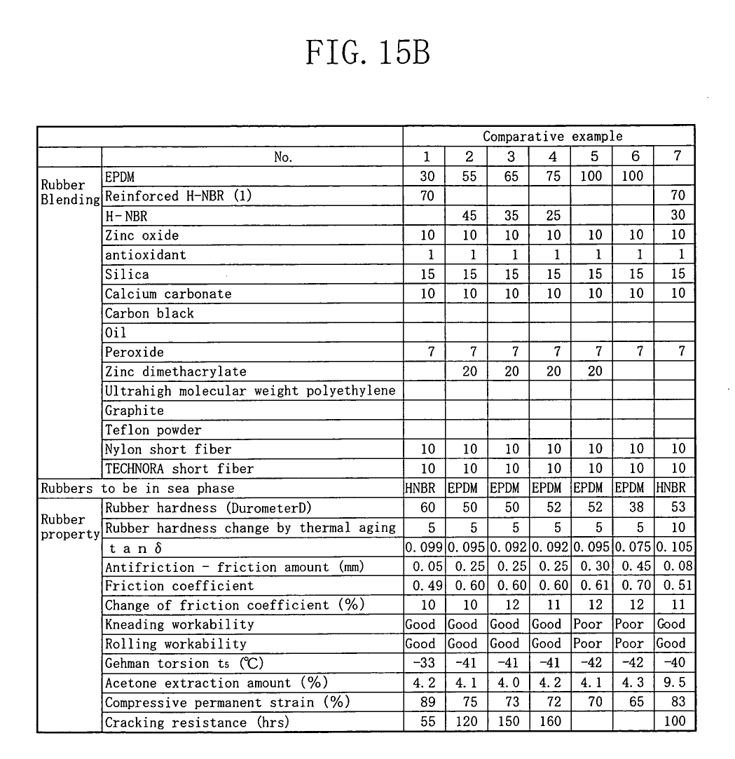

The belt B was wound and run between a large pulley 77 and a small pulley 78 in a belt running test apparatus of which layout was as shown in FIG. 12, and the results of the test for durability at low temperature were evaluated. The temperature of the atmosphere was set to −40° C. The large pulley 77 was driven at 270 rpm and no load was applied to the small pulley 78. A set weight was applied to the small pulley 78 so that a load of 9.8 N was applied to each rib of the belt B. The material of the large pulley 77 and the small pulley 78 was S45C, the diameter of the large pulley 77 and the small pulley 78 were set to 140 mm and 45 mm, respectively. Continuous belt running for 5 minutes and a halt for 25 minutes were set as one cycle. The number of the cycles until a crack was generated in the belt B was measured.

Evaluation Results in V Ribbed Belt

The results are indicated in the lower paragraph of FIG. 17 together with the rubber properties. The EPDM and the reinforced H-NBR (1) were employed as a material rubber in the invention examples 16 to 19, wherein the rubber hardness in durometer type A was different by changing the amount of TECHNORA short fiber. In the invention examples 16 and 17, in which the rubber hardness was in the range between 80 and 90, the durability at high temperature and the durability at low temperature were both excellent. However, when the hardness exceeds 90 as in the invention examples 18 and 19, the cracking resistance became worse with a result of poor durability at high temperature.

In the invention examples 20 to 22, the EPDM and the reinforced H-NBR (2) were employed as a material rubber, wherein the hardness in durometer type A was different by changing the amount of the added oil. In the invention examples 20 and 21, in which the rubber hardness was in the range between 80 and 90, the durability at high temperature and the durability at low temperature were both excellent. However, when the hardness was below 80 as in the invention examples 22, the rubber was deformed severely and separated from the core wires, which means poor durability at high temperature.

Further, from the invention example 22, in which the acetone extraction amount exceeded 12%, it is considered that the permanent strain of the rubber is severe and durability at high temperature of the belt is poor.

As in the invention example 23, in which a H-NBR with 30% or more acrylonitrile amount was used and no oil was added, when the rubber hardness became too high and German torsion t₅ became higher than −35° C., no crack was generated and the durability at high temperature and the durability at low temperature became poor.

Therefore, for enhancing both the durability at high temperature and the durability at low temperature in application to friction belts that require middle-level duty of transmission power, such as V ribbed belts, it is understood from the above results of belt evaluation test that it is preferable that the rubber hardness of the rubber material composing it is in the range between 80 and 90 in durometer type A, t₅ in Gehman torsion test is set to −35° C. or lower and the acetone extraction amount is 12% or less. The same aspects are applied to raw edge V belts, wrapped V belts, flat belts and the like for middle-level duty to heavy duty power transmission, as well as V ribbed belts.

<Evaluation of Rubber Composition in Toothed Belt>

The toothed belts as shown in FIG. 8 were manufactured. The rubber tooth portions 61 were respectively formed of the rubber compositions according to the examples indicated in FIG. 18. The evaluation of the rubber compositions was carried out for results of the following tests.

Evaluation of Durability to Tooth Chipping in Heavy Duty Application

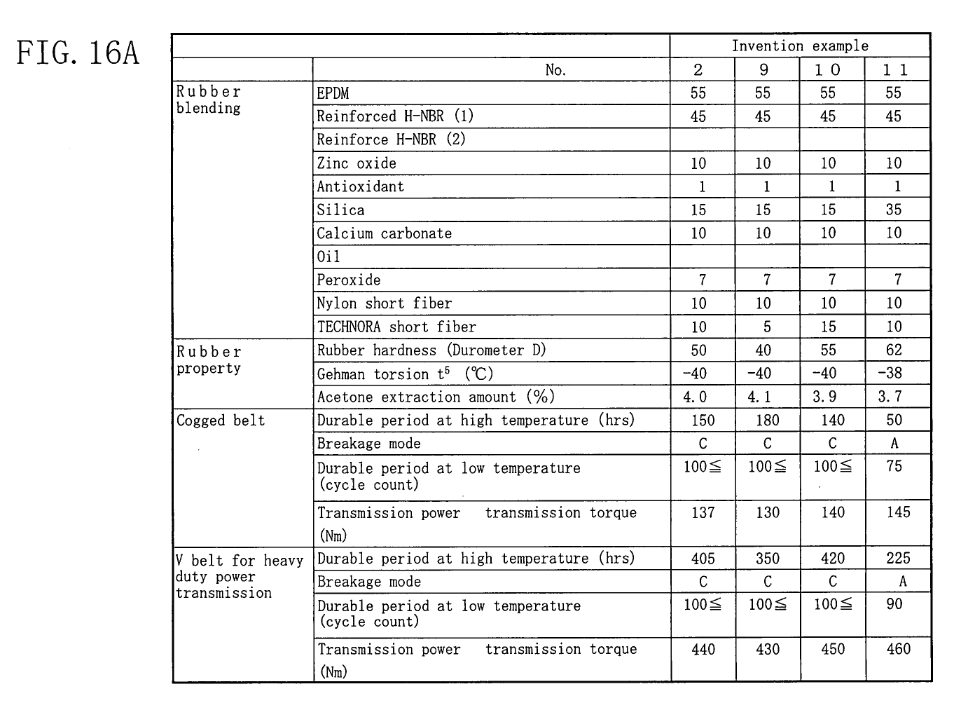

The toothed belts B in heavy duty application were tested for evaluation using a belt running test apparatus of which layout is shown in FIG. 13. In detail, the toothed belt B was wound around a drive pulley 81 whose periphery was formed into 21 pulley grooves, a driven pulley 82 whose periphery was formed into 42 pulley grooves, and an idler pulley 83 whose periphery for pressing the back face of the belt was flat and whose diameter was set to 32 mm, and a load was applied backward to the driven pulley 82 so as to apply a tension of 216 N to the belt B. The drive pulley 82 was rotated at 6000 rpm while applying a load of 60 Nm to the driven pulley 82. The temperature of the atmosphere was set to 100° C. The running period until tooth chipping occurs was measured as a lifetime of the belt tooth portion.

Evaluation of Durability to Tooth Chipping at Low Temperature

With a layout equivalent to that used in the evaluation of durability to tooth chipping in heavy duty application, a test was carried out under the conditions that: no load was applied to the driven pulley; the temperature of the atmosphere was set to −40° C.; and one-minute running and 30-minute cooling were set as one cycle. Then, the running period until tooth chipping occurs was measured as a lifetime of the belt tooth portion.

Evaluation Results for Toothed Belt

The results are indicated in the lower paragraph of FIG. 18 together with the rubber properties. In the invention examples 16 and 17, the EPDM and the reinforced H-NBR (1) were employed as a material rubber and the hardness in durometer type A was different by changing the amount of TECHNORA short fiber. The invention examples 16 and 17, which had the rubber hardness in the range between 80 and 90, were excellent in durability at high temperature and durability at low temperature. In detail, the invention example 17 having high rubber hardness was more excellent in durability at high temperature.

In the invention examples 25 and 26, the content of the reinforced H-NBR (1) was increased compared with those in the invention examples 16 and 17 and the rubber hardness in durometer type A was different by changing the amount of silica. When the rubber hardness exceeds 95 as in the invention example 26, the cracking resistance of the rubber became worse, resulting in degradation of durability to tooth chipping in heavy duty application.

In the invention examples 20, 21 and 24, the EPDM and the reinforced H-NBR (2) were employed as a rubber material and the rubber hardness in durometer type A was different by changing the addition amounts of TECHNORA short fiber and the oil. In the invention examples 20 and 21, of which rubber hardness was in the range between 80 and 90, the durability at high temperature and the durability at low temperature were both excellent. However, when the rubber hardness was below 80 as in the invention example 24, deformation of the rubber tooth portion became severe in heavy duty application and separation of a rubber tooth from the core wires occurred, which means poor durability to tooth chipping. In the invention example 24, in which the acetone extraction amount exceeded 10%, permanent strain of the rubber became severe, so as to promote tooth chipping by separation of a rubber tooth from the core wires.

When the reinforced H-NBR (2) of which acrylonitrile amount was 30% or more and no oil was added as in the invention example 23, t₅ in Gehman torsion was higher than −35° C. and the cracking resistance of the rubber at low temperature was worse, with a result that durability to tooth chipping at low temperature was worse.

From the above belt evaluation results, it is preferable for obtaining sufficient durability to tooth chipping in heavy duty application and at low temperature in application to toothed belts for heavy duty power transmission to prepare the rubber materials so that the rubber hardness in durometer type A is in the range between 80 and 95, t₅ in Gehman torsion test is −35° C. or lower and the acetone extraction amount is 10% or less.

It is further understood by those skilled in the art that the foregoing description is a preferred embodiment of the disclosed compositions and that various changes and modifications may be made in the invention without departing from the spirit and scope thereof.

1. A rubber composition for a transmission belt, comprising:
an ethylene-α-olefin elastomer which composes a sea phase in a sea-island structure and of which ethylene content is 60 mass % or less;
a hydrogenated acrylonitrile-butadiene rubber which composes an island phase in the sea-island structure and of which bonded acrylonitrile content is 30 mass % or less;
a metal salt of unsaturated carboxylic acid dispersed in each of said ethylene-α-olefin elastomer in the sea phase and said hydrogenated acrylonitrile-butadiene rubber in the island phase; and
an organic peroxide.

2. The rubber composition for a transmission belt of claim 1, wherein
a blending ratio of said ethylene-α-olefin elastomer in the sea phase to said hydrogenated acrylonitrile-butadiene rubber in the island phase (ethylene-α-olefin elastomer/hydrogenated acrylonitrile-butadiene rubber) is set in a range from 50/50 to 90/10.

3. The rubber composition for a transmission belt of claim 1, wherein
said ethylene-α-olefin elastomer in the sea phase is any one of an ethylene-propylene copolymer, an ethylene-propylene-diene terpolymer and an ethylene-octene copolymer.

4. The rubber composition for a transmission belt of claim 1, wherein
a base composition of said ethylene-α-olefin elastomer is in amorphous grade.

5. The rubber composition for a transmission belt of claim 1, wherein
said ethylene-α-olefin elastomer in the sea phase has a Mooney viscosity ML₍₁₊₄₎ of 60 or more at 125° C.

6. The rubber composition for a transmission belt of claim 1, wherein
said metal salt of unsaturated carboxylic acid is zinc dimethacrylate or zinc diacrylate.

7. The rubber composition for a transmission belt of claim 1, wherein
a grain size of 50 mass % or more of said metal salt of unsaturated carboxylic acid is 0.1 μm or less.

8. The rubber composition for a transmission belt of claim 1, wherein
a grain size of said metal salt of unsaturated carboxylic acid is 0.3 μm or less.

9. The rubber composition for a transmission belt of claim 1, wherein
at least one inorganic whitish filler selected from a group of silica, talc, mica, calcium carbonate, zinc oxide and magnesium oxide is contained.

10. The rubber composition for a transmission belt of claim 1, being colored to white or being colored by adding a pigment.

11. The rubber composition for a transmission belt of claim 1, wherein
polyethylene powder having a ultrahigh molecular weight or a polyethylene fiber having a ultrahigh molecular weight is contained as a friction controlling agent.

12. A friction transmission belt for heavy duty power transmission, comprising:
a friction face portion formed of a rubber made of a crosslinked rubber composition for a power transmission belt, said rubber-composition containing:
an ethylene-α-olefin elastomer which composes a sea phase in a sea-island structure and of which ethylene content is 60 mass % or less;
a hydrogenated nitrile-butadiene rubber which composes an island phase in the sea-island structure and of which bonded acrylonitrile content is 30 mass % or less;
a metal salt of unsaturated carboxylic acid dispersed in each of said ethylene-α-olefin elastomer in the sea phase and said hydrogenated acrylonitrile-butadiene rubber in the island phase; and
an organic peroxide,
wherein a rubber hardness in durometr type D measured in accordance with JIS K6253 is in a range between 40 and 60, both inclusive, t₅ in a German torsion test at −35° C. or lower, and an amount of extracted acetone is 9% or less in said rubber composition.

13. A friction transmission belt for heavy duty power transmission, comprising:
a friction face portion formed of a rubber made of a crosslinked rubber composition for a transmission belt, said rubber composition containing:
an ethylene-α-olefin elastomer which composes a sea phase in a sea-island structure and of which ethylene content is 60 mass % or less;
a hydrogenated acrylonitrile-butadiene rubber which composes an island phase in the sea-island structure and of which bonded acrylonitrile content is 30 mass % or less;
a metal salt of unsaturated carboxylic acid dispersed in each of said ethylene-α-olefin elastomer in the sea phase and said hydrogenated acrylonitrile-butadiene rubber in the island phase; and
an organic peroxide,
wherein a rubber hardness in durometr type A measured in accordance with JIS K6253 is in a range between 80 and 90, both inclusive, t₅ in a German torsion test is −35° C. or lower, and an amount of extracted acetone is 12% or less in said rubber composition.

14. A toothed belt, comprising:
a friction face portion formed of a rubber made of a crosslinked rubber composition for a transmission belt, said rubber composition containing:
an ethylene-α-olefin elastomer which composes a sea phase in a sea-island structure and of which ethylene content is 60 mass % or less;
a hydrogenated acrylonitrile-butadiene rubber which composes an island phase in the sea-island structure and of which bonded acrylonitrile content is 30 mass % or less;
a metal salt of unsaturated carboxylic acid dispersed in each of said ethylene-α-olefin elastomer in the sea phase and said hydrogenated acrulonitrile-butadiene rubber in the island phase; and
an organic peroxide,
wherein a rubber hardness in durometr type A measured in accordance with JIS K6253 is in a range between 80 and 95, both inclusive, t₅ in a German torsion test is −35° C. or lower, and an amount of extracted acetone is 10% or less in said rubber composition.

15. A method of manufacturing a rubber composition for a power transmission belt containing:
an ethylene-α-olefin elastomer which composes a sea phase in a sea-island structure and of which ethylene content is 60 mass % or less;
a hydrogenated nitrile-butadiene rubber which composes an island phase in the sea-island structure and of which bonded acrylonitrile content is 30 mass % or less;
a metal salt of unsaturated carboxylic acid dispersed in each of said ethylene-α-olefin elastomer in the sea phase and said hydrogenated acrylonitrile-butadiene rubber in the island phase; and
an organic peroxide,
said method comprising the step of:
kneading a hydrogenated acrylonitrile-butadiene rubber containing a composition of a metal salt of unsaturated carboxylic acid, an ethylene-α-olefin elastomer excluding a composition of a metal salt of unsaturated carboxylic acid, and compounding ingredeient for rubber containing an organic peroxide.
